(19) United States
(12) Patent Application Publication
(10) Pub. No.: US 2012/0200114 A1
(43) Pub. Date: Aug. 9, 2012

(54) HEADER SYSTEM FOR LIFT GATES

(75) Inventors: Robert L. McNiel, Corona, CA (US); Levon Hambardzumyan, Glendale, CA (US)

(73) Assignee: RS DRAWINGS ,LLC, Santa Fe Springs, CA (US)

(21) Appl. No.: 13/500,297

(22) PCT Filed: Sep. 29, 2010
(86) PCT No.: PCT/US2010/050763

§ 371 Date: Apr. 4, 2012

Related U.S. Application Data
(60) Provisional application No. 61/250,401, filed on Oct. 9, 2009.

(51) Int. Cl. B60J 5/10; B23P 11/00; B60P 1/34

(52) U.S. Cl. 296/186.3; 296/56; 29/428

(57) ABSTRACT

A header assembly useful with a columnar lift gate is provided. In one embodiment, the header assembly includes an elongated header element having a top wall with distal ends, the top wall having an upwardly protruding edge portion extending between the distal ends. The header element is configured for horizontal coupling to an upper edge of a vehicle opening. The header assembly further comprises a pair of columnar sleeves, each columnar sleeve configured for transverse connection proximate a distal end of the header element. The columnar sleeves are configured for coupling along side edges of the vehicle opening in parallel to one another and perpendicular to the header element. Each columnar sleeve is configured for receiving an upper portion of a lifting column of a columnar lift gate mounted at said vehicle opening, each lifting column mounted to a side edge of the vehicle opening under a respective columnar sleeve.

### CROSS REFERENCE TO RELATED APPLICATIONS

This application claims priority to U.S. Provisional Patent Application Ser. No. 61/250,401 filed Oct. 9, 2009, incorporated herein by reference in its entirety.

### BACKGROUND OF THE INVENTION

1. Field of the Invention

The present invention relates generally to lift gates, and in particular, to a lift gate header assembly on a trailer body of a vehicle.

2. Description of Related Art

Lifts such as lift gates are typically mounted at a structure such as an opening at the rear of a vehicle to lift payloads on a platform from one level (e.g., ground level) up to another level (e.g., the bed of the vehicle), or vice versa.

One type of lift gate employs linkages to maintain the lift platform in a horizontal plane through the lifting range. The lift platform is attached to linkages by pivot members, which allow the lift platform to be pivoted. Operation of the lifting mechanism may also rotate the lift platform into an inverted, stowed position beneath the vehicle body. Hydraulic actuators and electric actuators are used to provide lifting force for moving the lift.

### BRIEF SUMMARY OF THE INVENTION

Embodiments of the present invention provide a lift gate header assembly and method for mounting header assembly on a vehicle opening, such as rear opening of a truck. In one embodiment a header assembly according to the invention comprises an elongated header element having a top wall with distal ends, the top wall having an upwardly protruding edge portion extending between the distal ends, wherein the elongated header element is configured for horizontal coupling to an upper edge of a vehicle opening. In one embodiment, the header system further comprises a pair of columnar sleeves, wherein the columnar sleeves are configured for coupling along side edges of the vehicle opening in parallel to one another and perpendicular to the elongated header element. In one embodiment, each columnar sleeve is configured for transverse connection proximate a distal end of the elongated header element.

In one embodiment the header assembly is configured for coupling to a columnar lift gate, wherein each columnar sleeve is configured for receiving an upper portion of a lifting column of a columnar lift gate mounted at said opening of the vehicle, each lifting column mounted to a side edge of the vehicle opening under a respective columnar sleeve. The lift gate includes a platform horizontally coupled between said lifting columns, wherein the elongated header element extends over a portion of the lift gate, when coupled to the upper edge of the vehicle opening. In one embodiment, the upwardly protruding edge portion of the elongated header element is configured for directing debris on the top wall of the elongated header element away from an area directly under the elongated header element when coupled to said upper edge of a vehicle opening extending outwardly from said upper edge of the vehicle opening over the area directly under the elongated header element. In one embodiment, the elongated header element comprises access openings proximate distal ends of the top wall providing access to the interior of the columnar sleeves.

These and other features, aspects and advantages of the present invention will become understood with reference to the following description, appended claims and accompanying figures.

### BRIEF DESCRIPTION OF THE DRAWINGS

FIG. 1 illustrates an exploded perspective view of a header assembly, according to an embodiment of the invention.

FIG. 2 illustrates a rear perspective view of a header member of a header element of the header assembly, according to an embodiment of the invention.

FIG. 3 illustrates a rear perspective view of a portion of the header member, according to an embodiment of the invention.

FIG. 4 illustrates an alternative rear perspective view of the header member, according to an embodiment of the invention.

FIG. 5 illustrates a perspective view of the assembled lift gate header assembly, according to embodiments of the invention.

FIG. 6A illustrates a rear perspective view of the assembled lift gate header assembly, according to an embodiment of the invention.

FIG. 6B illustrates another rear perspective view of the assembled lift gate header assembly in FIG. 6A, showing a runner column of a columnar lift gate coupled to the header assembly, according to an embodiment of the invention.

FIG. 7 illustrates a front view of the assembled lift gate header assembly, according to an embodiment of the invention.

FIG. 8 illustrates a side view of the assembled lift gate header assembly, according to an embodiment of the invention.

FIG. 9 illustrates a bottom view of the assembled lift gate header assembly, according to an embodiment of the invention.

FIG. 10 illustrates a perspective view of the assembled lift gate header assembly coupled to the rear of the vehicle with a columnar lift gate, according to an embodiment of the invention.

FIG. 11 illustrates a front view of the lift gate header assembly coupled to the rear of the vehicle with a columnar lift gate, according to an embodiment of the invention.

FIG. 12 illustrates a side view of the lift gate header assembly coupled to the rear of the vehicle with a columnar lift gate, according to an embodiment of the invention.

FIG. 13 illustrates an alternative side view of the lift gate header assembly coupled to the rear of the vehicle, according to an embodiment of the invention.

FIG. 14 illustrates a method for coupling the lift gate header assembly to the rear of the vehicle, according to an embodiment of the invention.

### DETAILED DESCRIPTION OF THE INVENTION

The following description is made for the purpose of illustrating the general principles of the present invention and is not meant to limit the inventive concepts claimed herein. Further, particular features described within can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc.

Embodiments of the present invention provide a header assembly and method for mounting the header assembly on a vehicle opening, such as rear opening of a truck. In one embodiment a header assembly according to the invention comprises a device (e.g., kit) including an elongated header element having a top wall with distal ends, the top wall having an upwardly protruding edge portion extending between the distal ends, wherein the elongated header element is configured for horizontal coupling to an upper edge of a vehicle opening. In one embodiment, the header system further comprises a pair of columnar sleeves, each columnar sleeve configured for transverse connection proximate a distal end of the elongated header element. Wherein, the columnar sleeves are further configured for coupling along side edges of the vehicle opening in parallel to one another and perpendicular to the elongated header element.

In one embodiment the header assembly is configured for coupling to a columnar lift gate, wherein each columnar sleeve is configured for receiving an upper portion of a lifting column of a columnar lift gate mounted at said opening of the vehicle, each lifting column mounted to a side edge of the vehicle opening under a respective columnar sleeve. The lift gate includes a platform horizontally coupled between said lifting columns, wherein the elongated header element extends over a portion of the lift gate, when coupled to the upper edge of the vehicle opening. In one embodiment, the upwardly protruding edge portion of the elongated header element is configured for directing debris on the top wall of the elongated header element away from an area directly under the elongated header element when coupled to said upper edge of a vehicle opening extending outwardly from said upper edge of the vehicle opening over the area directly under the elongated header element. In one embodiment, the elongated header element comprises access openings proximate distal ends of the top wall providing access to the interior of the columnar sleeves.

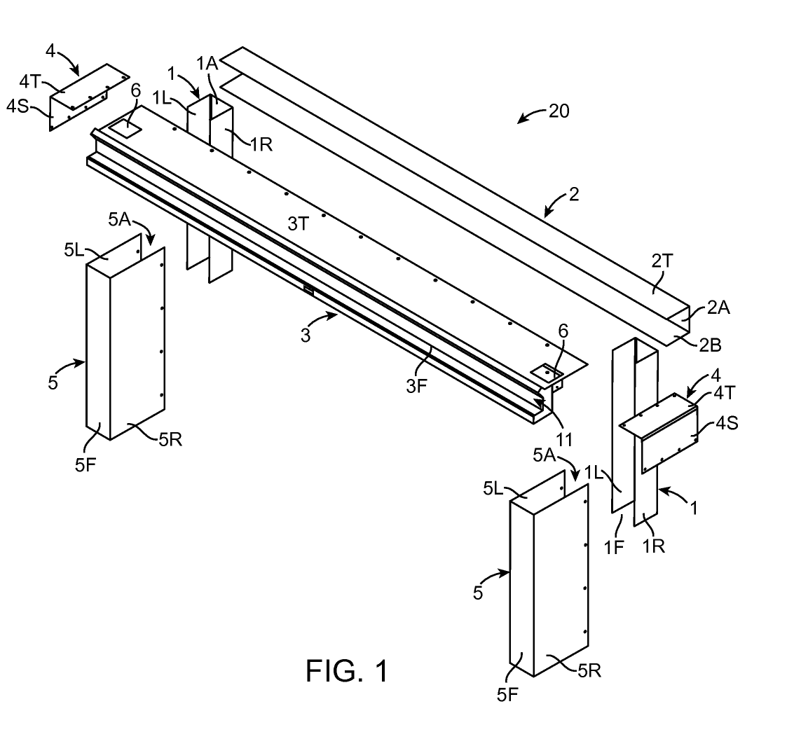

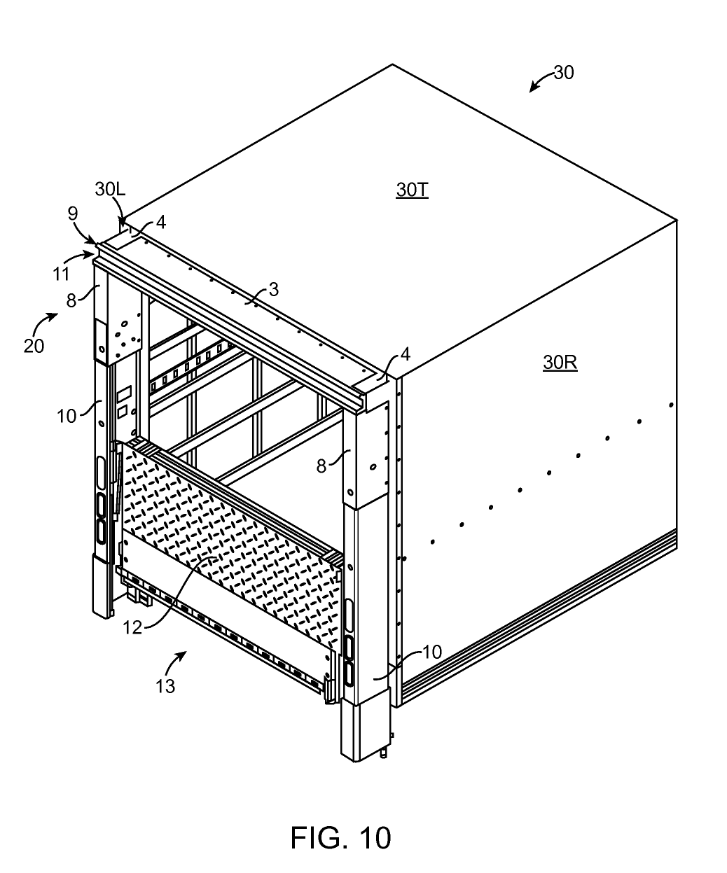

In one embodiment, the header system comprises a header assembly device (e.g., kit). FIG. 1 illustrates an exploded (unassembled) perspective view of a header assembly device 20, according to an embodiment of the invention. The header assembly 20 can be assembled and mounted on a trailer body 30 (FIG. 10) of a vehicle.

In one embodiment, the header assembly 20 is configured such that when it is assembled and coupled to the trailer body of a vehicle, the header assembly redirects debris away from a platform (such as a lift gate platform) located below the mounted header assembly 20. In one embodiment, the header assembly 20 is configured to allow placement of vehicle identification information and/or lighting thereupon. The identification and/or lighting are protected from damage when the vehicle abuts a docking bay by the design of the header assembly 20. In the description here, embodiments of a header assembly according to the invention are described in relation to a columnar lift gate and lift gate platform. However, a header assembly according to the invention is useful with other lift gates and is also useful without a lift gate.

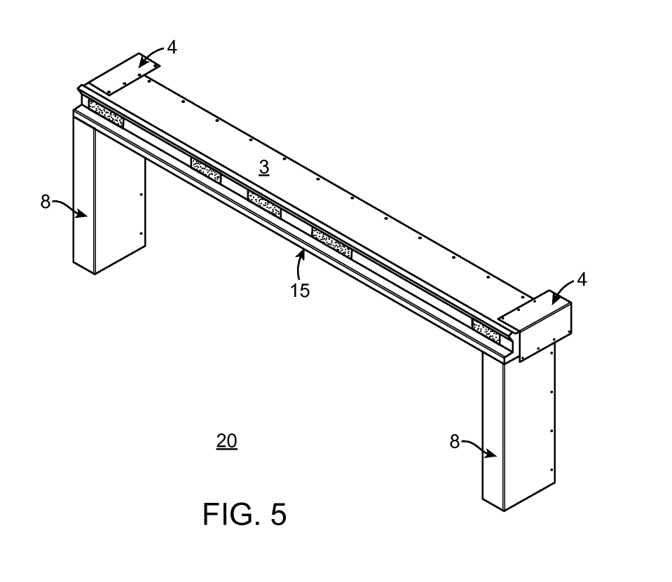

FIG. 1 shows an exploded view of an embodiment of a header assembly 20, and FIG. 5 shows a perspective view of the header assembly 20 in assembled configuration, according to embodiments of the present invention. In the assembled configuration, the header assembly 20 comprises a header element 15 and a pair of columnar sleeves 8. Specifically, the header assembly 20 comprises a first pair of elongated vertical channel members 1, each channel member 1 having an essentially U-shaped profile (cross section) with an opening 1F, a rear wall 1A, a left wall 1L, and a right wall 1R. The header assembly 20 further comprises a second pair of elongated vertical channel members 5, each channel member 5 having an essentially U-shaped profile with an opening 5A, a front wall 5F, a left wall 5L, and a right wall 5R.

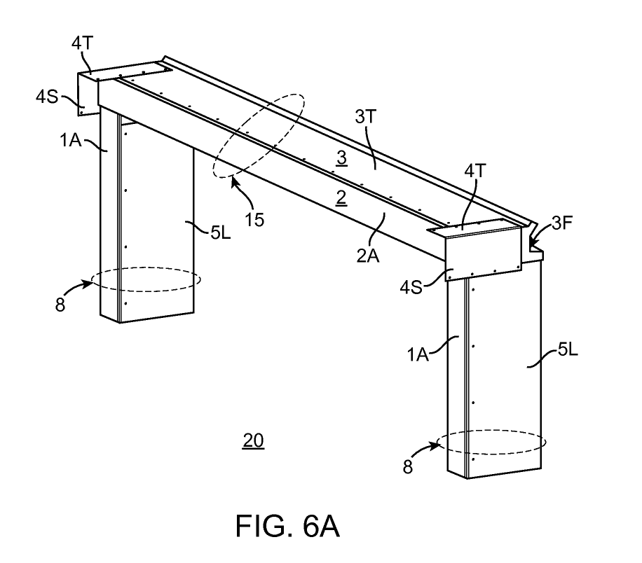

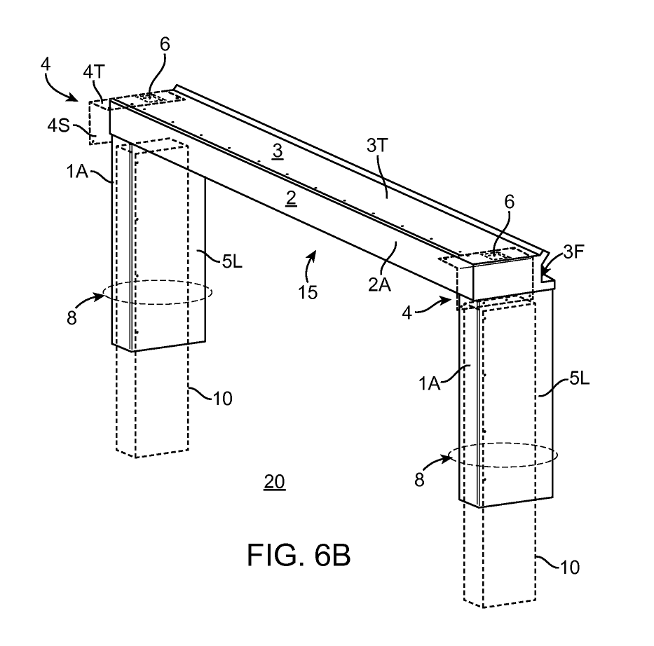

The second pair of channel members 5 corresponds to the first pair of channel members 1 to form said pair of columnar sleeves 8 when assembled, as shown by a perspective view of the header assembly 20 in FIGS. 5 and 6A. Each vertical channel member 5 is configured to receive a corresponding channel member 1 when the open sides 1F and 5A of the channel members 1 and 5, respectively, face each other. As such, the three walls 5L, 5R, and 5F of each channel 5 and corresponding walls 1L, 1R, and 1A of channel 1 together form a columnar sleeve 8. Each columnar sleeve has an essentially elongate hollow cylindrical shape with a generally rectangular cross-section.

The header assembly 20 further comprises a pair of brackets 4, each bracket 4 having an L-shaped profile with a top 4T and a side 4S. The header assembly 20 further comprises an elongated horizontal channel member 2 having an essentially U-shaped profile with a top wall 2T, a bottom wall 2B, a rear wall 2A and an open side 2F.

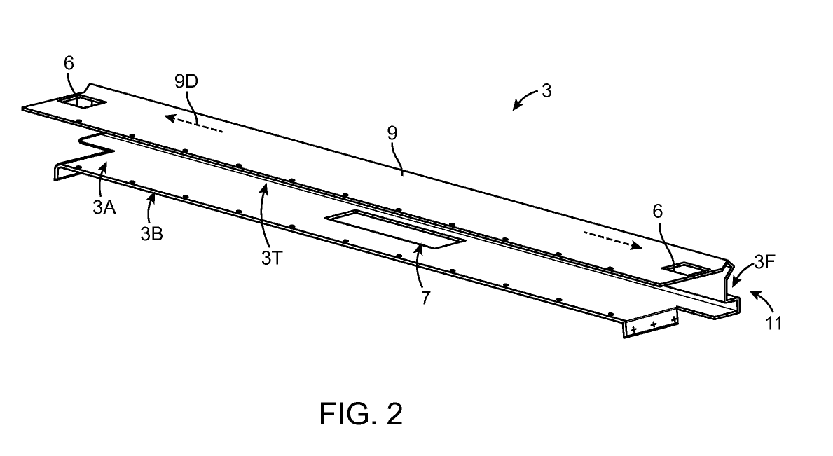

The header assembly 20 further comprises an elongated header member 3, corresponding to the horizontal channel 2. FIG. 2 illustrates a rear perspective view of the header member 3 having distal ends, according to an embodiment of the invention. The elongated header member 3 comprises a channel having a top wall 3T, a bottom wall 3B, a front wall 3F and an open side 3A. The opening 3A is configured such the horizontal channel member 2 (FIG. 1) can be assembled to the elongated header member 3 with their open sides 2F and 3A, respectively, facing each other as shown in FIG. 6A. A portion of the channel 2 is inserted into the opening 3A of the channel 3, wherein the channels 2 and 3 together form said header element 15, having an essentially elongate hollow cylindrical shape with a generally rectangular cross-section.

An opening 7 on the bottom wall 3B of the header member 3 allows for attachment of lighting equipment thereto capable of illuminating the area below the header assembly 20. For example, with the header assembly 20 coupled to the rear of the vehicle (FIG. 10), a light can be attached in the opening 7 of the header member 3 illuminating the lift gate platform 12 positioned below the header assembly 20 for human operators working around the trailer body 30.

The front wall 3F of the header member 3 further comprises an elongate depression 11 along at least a portion of its length where vehicle identification (ID) information may reside. The depression 11 also provides adequate space for Department of Transportation (DOT) markings, placards, labels, etc., or lighting equipment as required by local laws. In one example, the depression 11 is U-shaped in profile such as an elongated trough, wherein identification markings and/or lighting equipment attached to the header 3 are subset on the front header wall 3F.

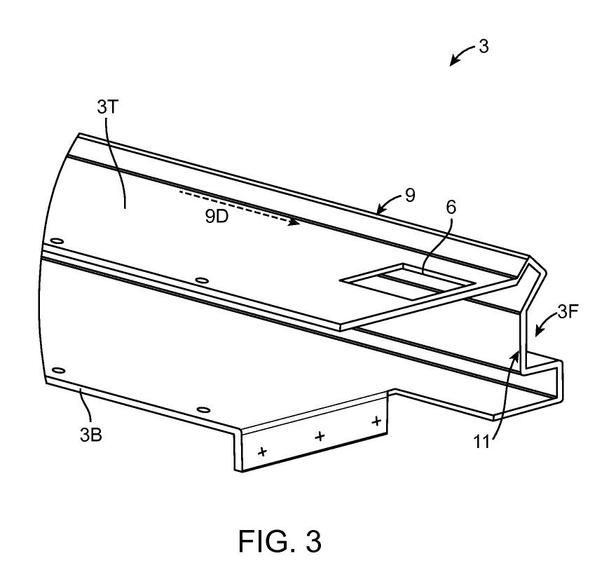

FIG. 3 illustrates a rear perspective view of a portion of the header member 3, according to an embodiment of the invention, enlarged for better showing relevant details thereof. The header member 3 includes upwardly slanted (sloped) ridge 9 at the intersection of the top wall 3T and front wall 3F of the header member 3. The ridge 9 functions to direct debris (e.g. rain water, dirt, dust, rocks, etc.) collecting on the top wall 3T of the header member 3 towards at least one side of the header member 3, such as along the arrow 9D. By redirecting debris towards the sides of the header member 3, the ridge 9 prevents debris from falling onto the lift gate platform 12 residing below the header assembly 20 (FIG. 10).

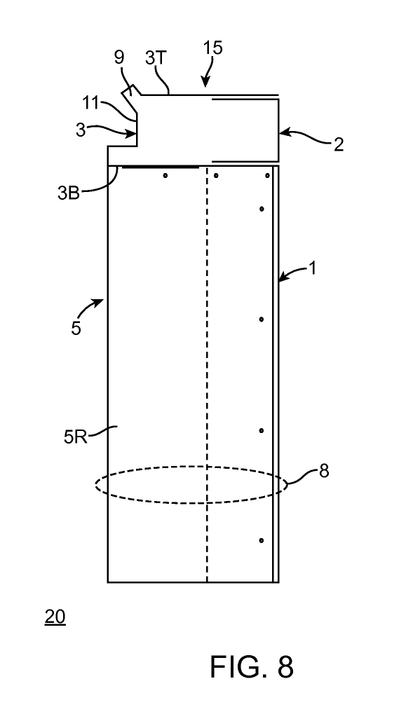

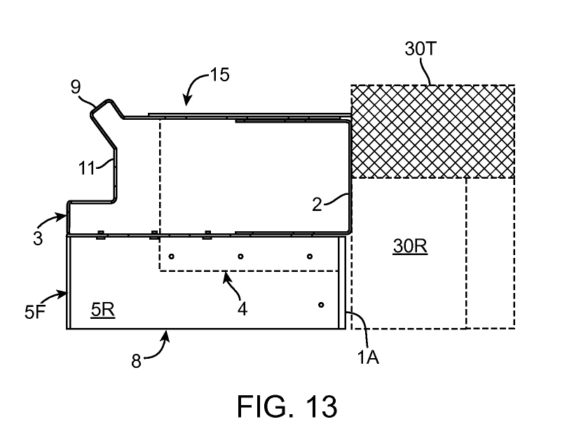

As shown by a side view of the assembled header assembly 20 in FIG. 8, in one embodiment of the header member 3, the ridge 9 is a U-shaped protrusion at the outward edge of the top wall 3T of the header member 3 and rising above top 3T of the header member 3. As shown by a side view of the assembled header assembly 20 in FIG. 13 as mounted to a trailer body 30T, in one embodiment, the ridge 9 of the header member 3 does not extend beyond the top of the trailer body 30T (FIG. 13) in the vertical direction.

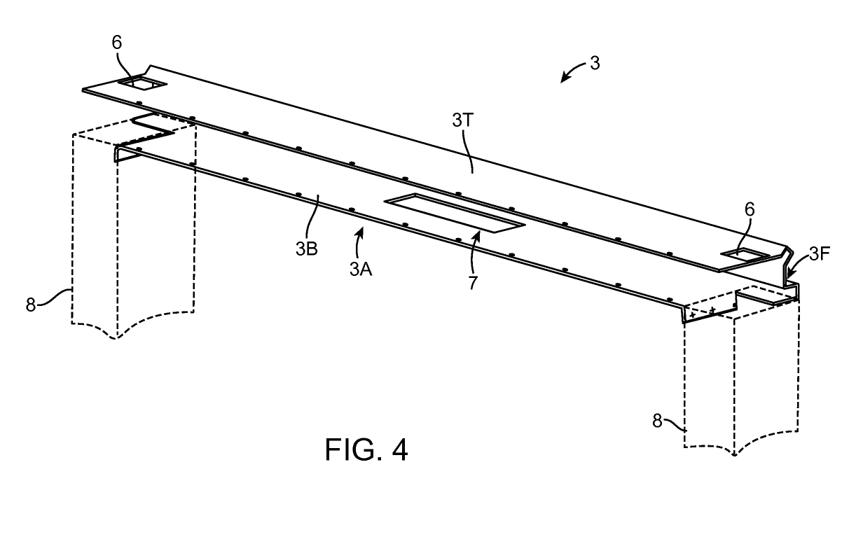

FIG. 4 illustrates an alternative rear perspective view of the header member 3, according to an embodiment of the invention, showing that the header member 3 further comprises a pair of openings 6 on the top wall 3T of the header 3, each opening 6 positioned towards one side (distal end) of the top wall 3T of the header member 3. Each opening 6 is formed to vertically line up with a corresponding columnar sleeve 8, and provide access to the interior of the corresponding columnar sleeve 8.

The bottom wall 3B of the header member 3 is shorter in the horizontal direction than the top wall 3T of the header 3. This feature allows for each columnar sleeve 8 formed by assembled channel member 5 and 1 (FIG. 6A) to interface with the header member 3 and allow access to the sleeve 8 via an access opening 6, without obstruction from the bottom wall 3B of the header member 3. In this configuration, each access opening 6 vertically line up with a corresponding columnar sleeve 8, and provides access to the interior of the corresponding columnar sleeve 8.

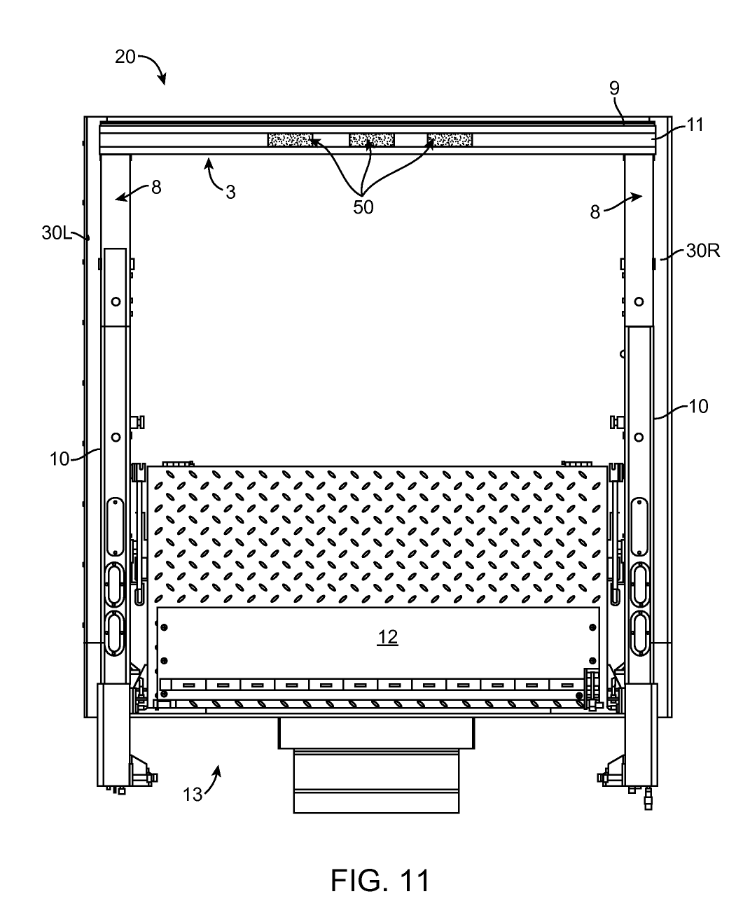

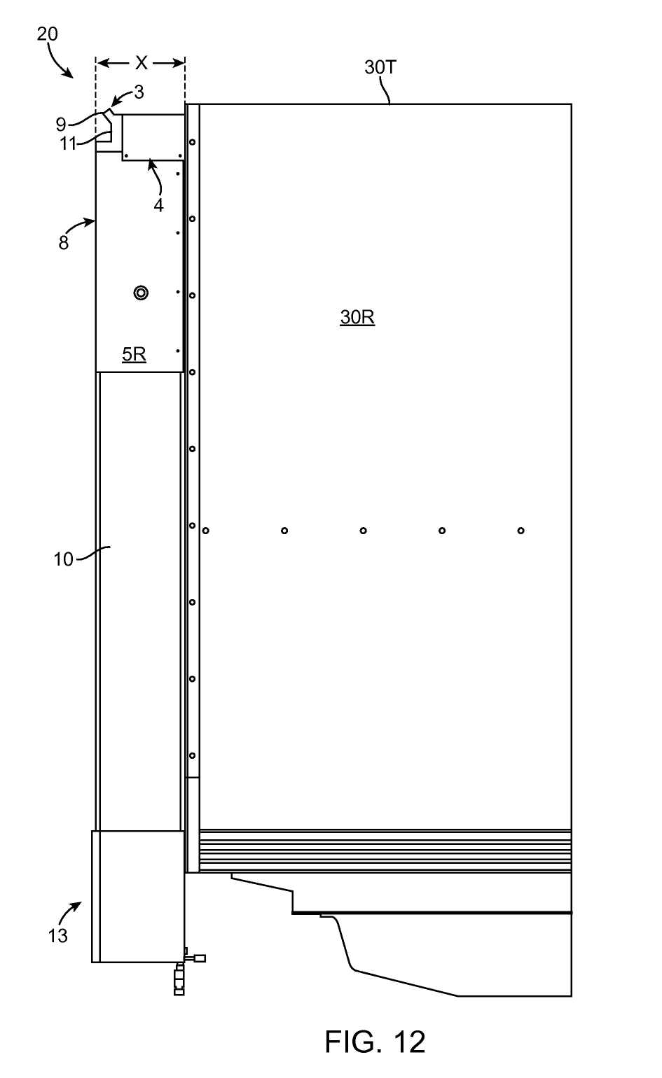

Each opening 6 further vertically aligns with columns of a columnar lift gate so that when the lift header assembly 20 is coupled to a vehicle body 30 (FIGS. 10-12), the openings 6 provide access to components residing within the lift gate columns. Specifically, FIG. 10 illustrates a perspective view of the assembled header assembly 20 coupled to the rear of the vehicle 30 with a columnar lift gate 13, and FIG. 11 shows a front view thereof, according to an embodiment of the invention. Further, FIG. 12 shows a side view of the lift gate header assembly coupled to the rear of the vehicle with a columnar lift gate 13 in FIGS. 10-11.

The lift gate 13 comprises a dual lift system including a parallel pair of vertically extending columns 10, each having a vertically disposed hydraulic cylinder for vertically raising and lowering a load carried by the pair of cylinders. The pair of cylinders may be actuated from a source of hydraulic power and the hydraulic circuit contains a flow divider distributing hydraulic flow to each of the cylinders.

As shown in FIGS. 10-12, an example columnar lift gate 13 comprises said pair of vertical columns 10 (e.g., having rectangular profile or cross-section) each containing a runner assembly (not shown) mounted for vertical reciprocation within the columns 10 (FIG. 10). Each runner assembly (i.e., runner) is typically engaged with interior tracks or surfaces of the companion column 10 by means of rollers. Actuators are used to provide lifting force for moving the runners. A foldable lift platform 12 is horizontally attached between the runners of the columns 10, wherein the vertical reciprocation of the runners moves the lift platform 12 up and down for raising/lowering objects on the platform 12. FIGS. 10 and 11 demonstrate the platform 12 folded up in the stowed (or travelling) position. Other lift gate assemblies may be utilized.

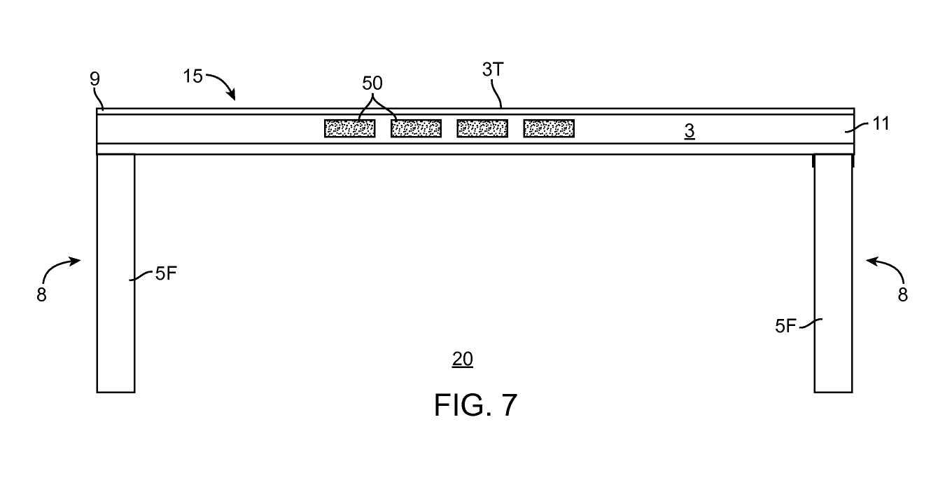

FIG. 5 illustrates a front perspective view of the assembled lift gate header assembly 20, according to embodiments of the invention. When assembled, the header member 3 rests atop vertical columnar sleeves 8, wherein the columnar sleeves 8 have a parallel relationship to one another. The brackets 4 may be removably coupled (e.g., via screws) at the peripheries of the top wall 3T of the header member 3 as shown, and cover the pair of openings 6 directly above the columnar sleeves 8. FIG. 5 also demonstrates the identification information and/or lighting 50 (FIG. 7) on the front wall 3F of the header member 3, specifically in the depression 11 formed on the front wall 3F.

As noted, FIG. 6A illustrates a rear perspective view of the assembled lift gate header assembly 20, according to an embodiment of the invention. The two columnar sleeves 8 are configured to receive at least top portions of the columns 10 of the lift gate 13 (FIG. 10). FIG. 6A also illustrates assembled members 2 and 3. The openings 6 (FIG. 6B) located on the top wall 3T of the header member 3 are covered by the top 4T of brackets 4. This ensures debris does fall into the openings 6 and sleeves 8 coming in contact with the columns 10 of the lift gate 13. In one embodiment, removable brackets 4 are removed to provide access to the interior of the sleeves 8 and columns 10 via the access openings 6. Thereafter, the brackets 4 may be reattached to the distal ends of the header element 15 to cover the access openings 6.

FIG. 6B illustrates another rear perspective view of the assembled header assembly 20 in FIG. 6A, showing a runner column 10 of the columnar lift gate 13 engaged to the header assembly 20, according to an embodiment of the invention. In this example, when the header assembly 20 is mounted on the lift gate 13, the top portion of each column 10 of the lift gate 13 is received by a corresponding sleeve 8 and is accessible via an opening 6 on the top wall 3T of the header member 3. As such, the interior of the columns 10 are accessible through respective openings 6 in the top wall 3T of the header member 3. In one embodiment of the present invention, the columnar sleeves 8 may be trimmed such that the columns 10 pass through only a portion (e.g., ¼, ½, ¾, etc.) of the sleeves 8.

FIG. 7 illustrates a front view of the assembled lift gate header assembly 20 in FIG. 5, according to an embodiment of the invention. In FIG. 7, only the front wall 5F of channel members 5, which coupled with channel members 1 form the columnar sleeves 8, are visible. The header member 3 also obscures view of the elongated rectangular channel 2 located directly behind the header member 3. FIG. 7 identifies the trough 11 in the front wall 3F of the header 3 where identification information and/or lighting equipment 50 may reside. FIG. 7 also shows the ridge 9 located at the intersection of the front wall 3F and top wall 3T of the header member 3.

FIG. 8 illustrates a right side view of the assembled lift gate header assembly 20 in FIG. 5, according to an embodiment of the invention. A columnar sleeve 8 interfaces with the header member 3 at the bottom wall 3B of the header 3 and bottom wall 2B of the channel member 2. The header member 3 is coupled to the elongated rectangular channel 2 to form a walled hollow form. This view shows the depression 11 in the front wall of the header member 3. FIG. 8 also exemplifies the ridge 9 in the header 3 which redirects debris from falling onto the lift gate platform 12 located below the header assembly 20 (FIG. 10).

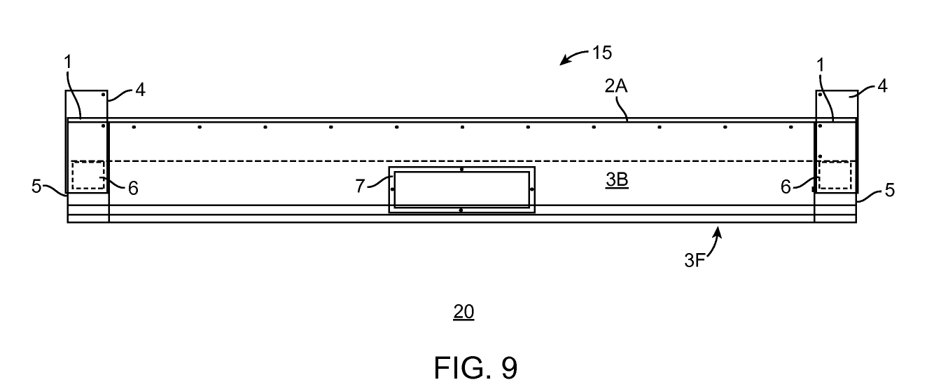

FIG. 9 illustrates a bottom view of the lift gate header assembly 20, according to an embodiment of the invention. FIG. 9 shows the bottom wall 3B of the header 3 having the opening 7 which may contain lighting equipment. This view also demonstrates that openings 6 are located directly above the sleeves created by coupled channel members 1 and 5; providing access to the components of columns 10 residing below the sleeves 8.

As noted, FIG. 10 illustrates a perspective view of the header assembly 20 coupled to the rear of the trailer body 30 having said column-style lift gate 13 attached thereto, according to an embodiment of the invention. The vertical pair of columns 10 are positioned along, and coupled to, the sides/edges 30R, 30L, of the trailer body 30. The foldable lift platform 12 is horizontally attached to the columns 10, wherein the vertical reciprocation of the runners of columns 10 move the lift platform 12 up and down for raising/lowering objects on the platform 12. Each hollow columnar sleeve 8 formed by coupling a pair of channel members 1 and 5 (FIG. 6A), is positioned directly over an upper portion of a corresponding column 10. Both columnar sleeves 8 are couples to the trailing ends of side 30R, 30L, of the vehicle body 30.

A rear facet of the header assembly 20 formed by the back wall 2A of the elongated rectangular channel 2 (FIG. 9) is coupled to the trailer body 30 near the top 30T and the trailer body 30 (FIG. 10). The top 4T of brackets 4 are coupled to the top wall 3T (FIG. 6A) of the header member 3 and the top wall 30T of the trailer body 30. The sides 4S of brackets 4 (FIG. 6A) further couple to channel members 8 and the sides 30R, 30L, of the trailer body 30 to further secure the header assembly 20 to the rear of the vehicle 30.

In one embodiment of the present invention, the depression 11 in the front wall of the header 3 faces outward relative to the rear of the truck body 30, providing a location for installing identification and/or lighting equipment. Further, the upwardly angled/slanted ridge 9 located at the intersection of the front wall 3F and top wall 3T wall of the header member 3 (FIG. 13) may be positioned so as not to exceed the height of the top 30T of the trailer body 30. The ridge 9 further redirect debris to the sides of the top wall 3T of the header member 3, away from the lift gate platform 12 below and to towards the sides 30R, 30L, of the vehicle.

As noted, FIG. 11 illustrates a front view of the header assembly 20 coupled to the rear of the trailer body with the lift gate 13, according to an embodiment of the invention. The elongated header member 3 is sufficiently wide relative to the width of both the top of the trailer and lift gate platform 12 to ensure debris is redirected away from the lift gate platform 12 by the ridge 9. The depression 11 in the front wall of the header 3 also provides a sufficient amount of space for trailer body 30 identification and/or lighting 50 to reside.

As noted, FIG. 12 illustrates a side view of the lift gate header assembly 20 coupled to the rear of the vehicle, according to an embodiment of the invention. The example dimension X shown in FIG. 12 identifies the maximum distance the lift gate header assembly 20 may reside from the rear of a vehicle body 30 in accordance with local/federal vehicle regulations.

FIG. 13 illustrates close-up side view of the header assembly 20 coupled to the rear of the vehicle 30, according to an embodiment of the invention. As exemplified, the header assembly 20 is coupled to the rear of a vehicle body 30 in such a manner that the ridge 9 in the header member 3 does not exceed the height of the top wall 30T of the vehicle body 30. FIG. 13 also demonstrates that when lights/identifying markings are installed in the recession 11, the lights/identifying markings do not extend in the horizontal direction past channel members 5.

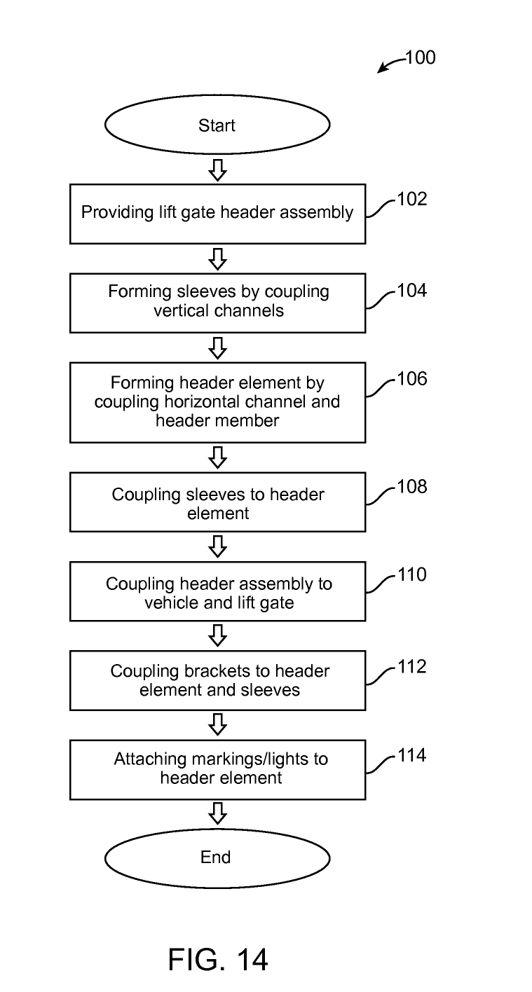

FIG. 14 illustrates a method 100 for coupling the header assembly 20 to the read of the vehicle, according to an embodiment of the invention. The method 100 begins with step 102 which comprises providing the header assembly 20. After providing the header assembly 20 in step 102, the method continues with step 104 which comprises forming the columnar sleeves 8.

Forming the columnar sleeves 8 (FIG. 6A) pursuant to step 104 comprises coupling channel members 1 with corresponding channel members 5. Specifically, the channel opening 1F is orientated to face the channel opening 5A during coupling. Sliding channel members 1 into openings 5A of channel members 5 results in the formation of columnar sleeves 8. Alternatively, formation of columnar sleeves 8 may entail sliding channel members 5 into channel members 1. After the columnar sleeves 8 are formed, step 104 is complete and the method 100 continues with step 106 which comprises coupling channel member 2 and header member 3 to form the header element 15 (FIG. 6A).

Coupling the header member 3 with the channel member 2 to form the header element 15 exemplified in FIG. 5 and FIG. 6A, comprises orientating the opening 2F of channel member 2 towards the opening 3A of the header member 3. Sliding the channel member 2 into the header member 3 creates the header element 15. After coupling the header member 3 and channel member 2 together, step 106 is complete and the method 100 continues with step 108 which comprises coupling the columnar sleeves 8 to the header element 15.

Coupling the sleeves 8 to the header element 15 as per step 108 comprises orientating each sleeve 8 in the vertical plane and aligning the sleeves perpendicular to the ends of the header element 15 (FIG. 7). Next, the sleeves 8 are placed in contact with the header member 3 (FIG. 4). This step is possible since a portion of the bottom wall 3B is shorter in length than the top wall 3T of the header, as exemplified in FIG. 3. After coupling the sleeves to the header element 15, step 108 is complete and the method 100 continues with step 110 which comprises coupling the header assembly 20 to the rear of a trailer 30 (FIG. 10). In an alternative embodiment, the sleeves 8 are not coupled to proximate ends of the header element 15. Rather the sleeves 8 are coupled to the left wall 30L and right wall 30R of the trailer body 30 and positioned proximate the header element 15 which is also attached to an upper edge of the vehicle opening, as shown.

Coupling the header assembly 20 to the rear of the trailer 30 and the lift gate 13 (FIG. 10) as per step 110 comprises sliding the upper portion of each column 10 into a sleeve 8 (e.g., by lowering the header assembly 20 from above onto the columns 10), and coupling the rear wall 2A of the channel member 2 of the header element 15 to an upper edge of the rear of the body of the vehicle 30 as exemplified in FIGS. 10, 12 and 13. Specifically, channel 2 is coupled to the top vehicle body 30 in a plane parallel to the top wall 30T (FIG. 10). With channel 2 coupled to the trailer body 30, the sleeves 8 are aligned with the left wall 30L and right wall 30R of the trailer body 30, facilitating coupling thereto. After the header assembly 20 is coupled to the trailer body, step 110 is complete and the method 100 continues with step 112 which comprises coupling the brackets 4 to the header 15 and sleeves 8.

Coupling the brackets 4 to the header 3 and sleeves 8 as per step 112 comprises coupling each bracket's top wall 4T to the top wall 3T of the header 3 (FIG. 10). Specifically, the top 4T of each bracket 4 covers an opening 6 in the top wall 3T of the header 3. Coupling the brackets 4 to the sleeves 8 comprises coupling the side wall 4S of each bracket to an outside edge of a sleeve 8 (FIG. 10). Thereafter, step 112 is complete and the method 100 continues with step 114 which comprises attaching lights to the opening 7 and depression 11 in the header 3 (FIG. 4).

Step 114 comprises attaching lights to the opening 7 in the bottom wall 3B of the header 3 (FIG. 4). Lighting and/or vehicle ID markings also coupled to the depression 11 in the front wall 3F of the header 3 (FIG. 7). After the lights and/or vehicle ID markings are coupled to the header assembly 20, step 114 is complete and the method 100 ends.

The header assembly 20 may be coupled to the lift gate 13 and trailer body in a different sequence than described above. For example, the sleeves 8 may be formed around the columns 10 first, and then the header element 15 attached to the sleeves 8 and the vehicle body.

The elements of the header assembly 20 (FIG. 1) may be assembled/coupled together via e.g., screws, rivets, welds, or other fastening devices. The header assembly 20 may be assembled/coupled/mounted to the vehicle opening and the lift gate 13 via e.g., screws, rivets, welds, or other fastening devices. The components of the header assembly kit 20 may be made of rigid materials such as metals and the like. Preferably, the elements of the lift gate header assembly 20 comprise galvanealed metal (a carbon steel sheet coated with zinc on both sides by the continuous hot dip process), providing added corrosion protection over standard steel.

In another embodiment, the present invention provides a system including said header assembly 20 and a lift gate (such as a columnar lift gate 13 in FIG. 10). In another embodiment, the header assembly 20 may be used without the columnar sleeves 8, wherein the elongated header element 15 is coupled to an upper edge of the vehicle opening.

The present invention has been described in considerable detail with reference to certain preferred versions thereof; however, other versions are possible. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A header device comprising:
an elongated header element having a top wall with distal ends, the top wall having an upwardly protruding edge portion extending between the distal ends, wherein the elongated header element is configured for horizontal coupling to an upper edge of a vehicle opening; and
a pair of columnar sleeves, each columnar sleeve configured for coupling along side edges of the vehicle opening in parallel to one another and perpendicular to the elongated header element, wherein each columnar sleeve is configured for receiving an upper portion of a lifting column of a columnar lift gate mounted at said opening of the vehicle internally within each columnar sleeve.

2. The header device of claim 1, wherein the pair of columnar sleeves have a length less than a lifting column of a columnar lift gate mounted at said opening of the vehicle.

3. The header device of claim 2, wherein:
each columnar sleeves is further configured for transverse connection proximate a distal end of the elongated header element;
the header element comprises an elongated header member having said top wall with distal ends, the upwardly protruding edge portion comprising a slanted ridge rising above the top wall and extending the distal ends of the elongated header member; and
each columnar sleeve has a hollow interior.

4. The header device of claim 3, wherein:
the elongated header member further comprises a bottom wall and a front wall, wherein the top wall, the bottom wall, and the front wall together form a channel having an essentially U-shaped cross-section, wherein the edge portion of the top wall is at an outward edge of the elongated header member at the intersection of the top wall and the front wall.

5. The header device of claim 4, wherein:
the front wall of the elongated header member includes a depression forming a trough extending between distal ends of the elongated header member, for attaching vehicle markings therein.

6. The header device of claim 4, wherein:
the bottom wall of the elongated header member includes an opening for attaching lighting equipment thereto to illuminate an area underneath the elongated header element.

7. The header device of claim 6, wherein:
the edge portion has an essentially U-shaped cross-section, and protrudes upwardly at a slant at said outward edge of the top wall of the elongated header member.

8. The header device of claim 4 wherein:
the elongated header element further comprises a pair of access openings proximate the distal ends of the elongated header element, each access opening corresponding to a columnar sleeve and providing access to the interior of the corresponding columnar sleeve proximate each distal end of the elongated header element.

9. The header device of claim 8, wherein:
each access opening is located proximate a distal end of the top wall of the elongated header member; and
said bottom wall of the elongated header member is shorter in length than the top wall between the distal ends of the elongated header element, allowing access from each access opening on the top wall to the interior of a respective columnar sleeve.

10. The header device of claim 9, further comprising:
a pair of brackets, each bracket corresponding to an access opening, wherein each bracket is configured for coupling to a distal end of the elongated header element;
each bracket having a top wall and side wall, wherein when coupled to the elongated header element, the top wall of each bracket covers the corresponding access opening in the top wall of the elongated header member.

11. The header device of claim 3, wherein:
the elongated header element further comprises an elongated channel member having an essentially U-shaped cross-section having an open side between distal ends thereof;
the open side of the channel member is configured for coupling to an open side of the elongated header member to form said elongated header element having an essentially rectangular cross-section, wherein a rear wall of the channel member is disposed opposing said front wall of the elongated header member;
wherein the rear wall of the channel member is configured for coupling to said upper edge of the vehicle opening.

12. The header device of claim 11 wherein:
the upwardly slanted edge portion is configured for directing debris on the top wall of the elongated header member away from the area directly under the elongated header element when coupled to said upper edge of a vehicle opening extending outwardly from said upper edge of the vehicle opening over the area directly under the elongated header element.

13. The header device of claim 12 wherein:
the upwardly slanted edge portion is configured for directing debris on the top wall of the elongated header member towards the distal ends of the elongated header element away from the area directly under the elongated header element when coupled to said upper edge of a vehicle opening extending outwardly from said upper edge of the vehicle opening over the area directly under the elongated header element.

14. The header device of claim 13, wherein:
each lifting column mounted to a side edge of the vehicle opening under a lower end of a respective columnar sleeve;
the lift gate including a platform horizontally coupled between said lifting columns, the elongated header element extending over a portion of the lift gate, when coupled to the upper edge of the vehicle opening.

15. The header device of claim 2, wherein:
each columnar sleeve comprises a first columnar channel having a U-shaped cross-section with an open side, and a second columnar channel having a U-shaped cross-section with an open side;
the open side of the first channel member is configured for coupling to the open side of the second columnar channel to form said columnar sleeve having an essentially rectangular cross-section.

16. A header assembly comprising:
an elongated header element having a top wall with distal ends, the top wall having an upwardly protruding edge portion, wherein the elongated header element is configured for horizontal coupling to an upper edge of a vehicle opening;
a pair of columnar sleeves, each columnar sleeve configured for transverse connection proximate a distal end of the elongated header element, wherein the columnar sleeves are configured for coupling along side edges of the vehicle opening in parallel to one another and perpendicular to the elongated header element;
wherein the elongated header element comprises an elongated header member having said top wall with distal ends, the upwardly protruding edge portion comprising a slanted ridge extending the distal ends of the elongated header member;
wherein the elongated header member further comprises a bottom wall and a front wall, wherein the top wall, the bottom wall, and the front wall together form a channel having an essentially U-shaped cross-section, wherein the edge portion of the top wall is at an outward edge of the elongated header member at the intersection of the top wall and the front wall; and
wherein each columnar sleeve comprises a first columnar channel having a U-shaped cross-section with an open side, and a second columnar channel having a U-shaped cross-section with an open side, wherein the open side of the first channel member is configured for coupling to the open side of the second columnar channel to form said columnar sleeve having an essentially rectangular cross-section, wherein each columnar sleeve is configured for receiving an upper portion of a lifting column of a columnar lift gate mounted at said opening of the vehicle internally within each columnar sleeve.

17. The header assembly of claim 16, wherein:
the edge portion has an essentially U-shaped cross-section, and protrudes upwardly at a slant at said outward edge of the top wall of the elongated header member, such that the edge portion rises above the top wall.

18. The header assembly of claim 16, wherein:
the elongated header element further comprises a pair of access openings proximate the distal ends of the elongated header element, each access opening corresponding to a columnar sleeve and providing access to the interior of the corresponding columnar sleeve proximate each distal end of the elongated header element.

19. The header assembly of claim 18, wherein:
each access opening is located proximate a distal end of the top wall of the elongated header member; and
said bottom wall of the elongated header member is shorter in length than the top wall between the distal ends of the elongated header element, allowing access from each access opening on the top wall to the interior of a respective columnar sleeve.

20. The header assembly of claim 19, wherein:
the elongated header element further comprises an elongated channel member having an essentially U-shaped cross-section having an open side between distal ends thereof;
the open side of the channel member is configured for coupling to an open side of the elongated header member to form said elongated header element having an essentially rectangular cross-section, wherein a rear wall of the channel member is disposed opposing said front wall of the elongated header member;
wherein the rear wall of the channel member is configured for coupling to said upper edge of the vehicle opening.

21. The header assembly of claim 20 wherein:
the upwardly slanted edge portion is configured for directing debris on the top wall of the elongated header member towards the distal ends of the elongated header element away from the area directly under the elongated header element when coupled to said upper edge of a vehicle opening extending outwardly from said upper edge of the vehicle opening over the area directly under the elongated header element.

22. The header assembly of claim 21, wherein:
each lifting column mounted to a side edge of the vehicle opening under a respective columnar sleeve, wherein each access opening provides access to a lifting column in a corresponding columnar sleeve;
the lift gate including a platform horizontally coupled between said lifting columns, the elongated header element and slanted edge portion extending over at least a portion of the lift gate, when coupled to the upper edge of the vehicle opening.

23. The header assembly of claim 22, further comprising:
a pair of brackets, each bracket corresponding to an access opening, wherein each bracket is configured for removably coupling to a distal end of the elongated header element;
each bracket having a top wall and side wall, wherein when coupled to the elongated header element, the top wall of each bracket covers the corresponding access opening in the top wall of the elongated header member.

24. The header assembly of claim 23, wherein:
the front wall of the elongated header member includes a depression forming a trough extending between distal ends of the elongated header member, for attaching vehicle markings therein; and
the bottom wall of the elongated header member includes an opening for attaching lighting equipment thereto to illuminate an area underneath the elongated header element.

25. A lift gate system, comprising:
a lift gate comprising a platform coupled to a pair of lifting columns, wherein each lifting column is configured for mounting to a side edge of a vehicle opening in parallel to the other lifting column;
a header device comprising an elongated header element having a top wall with distal ends, the top wall having an upwardly protruding edge portion, wherein the elongated header element is configured for horizontal coupling to an upper edge of the vehicle opening above the lift gate; and
pair of columnar sleeves, each columnar sleeve configured for transverse connection proximate a distal end of the elongated header element, wherein each columnar sleeve is further configured for receiving an upper portion of a lifting column of the lift gate mounted at said opening of the vehicle internally within each columnar sleeve.

26. The lift gate system of claim 25, further comprising:
wherein each columnar sleeve is further configured for coupling to a side edge of the vehicle opening in parallel to one another and perpendicular to the elongated header element;
wherein each lifting column mounted to a side edge of the vehicle opening under a respective columnar sleeve.

27. The lift gate system of claim 26, wherein:
the elongated header element comprises an elongated header member having said top wall with distal ends, the upwardly protruding edge portion comprising a slanted ridge rising above the top wall and extending the distal ends of the elongated header member;
the elongated header member further comprises a bottom wall and a front wall, wherein the top wall, the bottom wall, and the front wall together form a channel having an essentially U-shaped cross-section, wherein the edge portion of the top wall is at an outward edge of the elongated header member at the intersection of the top wall and the front wall; and
wherein each columnar sleeve comprises a first columnar channel having a U-shaped cross-section with an open side, and a second columnar channel having a U-shaped cross-section with an open side, wherein the open side of the first channel member is configured for coupling to the open side of the second columnar channel to form said columnar sleeve having an essentially rectangular cross-section.

28. The system of claim 27, wherein:
the edge portion has an essentially U-shaped cross-section, and protrudes upwardly at a slant at said outward edge of the top wall of the elongated header member.

29. The system of claim 27, wherein:
the elongated header element further comprises a pair of access openings proximate the distal ends of the elongated header element, each access opening corresponding to a columnar sleeve and providing access to the interior of the corresponding columnar sleeve proximate each distal end of the elongated header element.

30. The system of claim 29, wherein:
each access opening is located proximate a distal end of the top wall of the elongated header member; and
said bottom wall of the elongated header member is shorter in length than the top wall between the distal ends of the elongated header element, allowing access from each access opening on the top wall to the interior of a respective columnar sleeve.

31. The system of claim 30, wherein:
the elongated header element further comprises an elongated channel member having an essentially U-shaped cross-section having an open side between distal ends thereof;
the open side of the channel member is configured for coupling to an open side of the elongated header member to form said elongated header element having an essentially rectangular cross-section, wherein a rear wall of the channel member is disposed opposing said front wall of the elongated header member;
wherein the rear wall of the channel member is configured for coupling to said upper edge of the vehicle opening.

32. The system of claim 31 wherein:
the upwardly slanted edge portion is configured for directing debris on the top wall of the elongated header member towards the distal ends of the elongated header element away from the area directly under the elongated header element when coupled to said upper edge of a vehicle opening extending outwardly from said upper edge of the vehicle opening over the area directly under the elongated header element.

33. The system of claim 32, wherein:
each access opening provides access to a lifting column in a corresponding columnar sleeve;
the elongated header element and slanted edge portion extending over at least a portion of the lift gate, when coupled to the upper edge of the vehicle opening.

34. The system of claim 33, further comprising:
a pair of brackets, each bracket corresponding to an access opening, wherein each bracket is configured for removably coupling to a distal end of the elongated header element;
each bracket having a top wall and side wall, wherein when coupled to the elongated header element, the top wall of each bracket covers the corresponding access opening in the top wall of the elongated header member.

35. The system of claim 34, wherein:
the front wall of the elongated header member includes a depression forming a trough extending between distal ends of the elongated header member, for attaching vehicle markings therein; and
the bottom wall of the elongated header member includes an opening for attaching lighting equipment thereto to illuminate an area underneath the elongated header element.

36. A method for coupling a lift gate header device to a vehicle opening, comprising:
providing a lift gate header device, comprising:
an elongated header element having a top wall with distal ends, the top wall having an upwardly protruding edge portion, wherein the elongated header element is configured for horizontal coupling to an upper edge of the vehicle opening;
a pair of columnar sleeves, each columnar sleeve configured for transverse connection proximate a distal end of the elongated header element, wherein each columnar sleeve is further configured for coupling along a side edge of the vehicle opening;
mounting the header device to the vehicle opening by horizontally coupling the elongated header element to an upper edge of the vehicle opening, coupling each columnar sleeve along a side edge of the vehicle opening under the elongated header element, such that the columnar sleeves are parallel to one another and perpendicular to the header element, and coupling each columnar sleeves to a distal end of the elongated header element; and
each columnar sleeve receiving an upper portion of a lifting column of a columnar lift gate mounted at said opening of the vehicle internally within each columnar sleeve.

37. The method of claim 36, further comprising:
each lifting column mounted to a side edge of the vehicle opening under a respective columnar sleeve.
